(19) United States
(12) Patent Application Publication
(10) Pub. No.: US 2006/0072125 A1
(43) Pub. Date: Apr. 6, 2006

(54) Lens substrate, a method of manufacturing a lens substrate, a transmission screen and a rear projection

(75) Inventor: Nobuo Shimizu, Nagano (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/244,190

(22) Filed: Oct. 5, 2005

(30) Foreign Application Priority Data
Oct. 5, 2004 (JP) 2004-292923

(51) Int. Cl. G01B 11/28

(52) U.S. Cl. 356/630

(57) ABSTRACT

A lens substrate 1 having a first surface and a second surface opposite to the first surface is disclosed. Light is allowed to enter the lens substrate 1 from the first surface thereof and then exit from the second surface thereof. The lens substrate includes: a plurality of convex lenses 21 formed on the first surface of the lens substrate 1 from which the light is allowed to enter the lens substrate 1; and a total reflection preventing means 22 provided on the second surface of the lens substrate 1 for preventing the light entering the lens substrate 1 from being totally reflected in the vicinity of the second surface thereof.

### CROSS-REFERENCE TO RELATED APPLICATION

This application claims priority to Japanese Patent Application No. 2004-292923 filed Oct. 5, 2004, which is hereby expressly incorporated by reference herein in its entirety.

### FIELD OF THE INVENTION

The present invention relates to a lens substrate, a method of manufacturing a lens substrate, a transmission screen, and a rear projection.

### BACKGROUND OF THE INVENTION

In recent years, demand for a rear projection (such as a rear projection type television) is becoming increasingly strong as a suitable display for a monitor for a home theater, a large screen television, or the like. In such a rear projection, in order to improve contrast of an image to be projected, it is required to inhibit the reflection of outside light from an emission side (that is, viewer side) of the image light of the rear projection while inhibiting a drop of the intensity of the image light. In order to achieve such an object, JP-A-7-104385 discloses a transmission screen in which a translucent front panel whose surface is subjected to mat processing and/or hairline processing is provided at the emission surface side of light in a lenticular lens.

However, in the case of being subjected to the processing described above, it is possible to inhibit reflection of outside light, but it has been unavoidable that incident light for forming an image may be totally reflected in the vicinity of the emission surface of light of a lenticular lens sheet. More specifically, in the case of being subjected to the processing described above, portions in which the angle of incidence of light becomes more than the critical angle necessarily exists at the interface between the emission surface of light of the lenticular lens sheet and the atmosphere in which the lenticular lens sheet is placed (in this case, the absolute index of refraction of the atmosphere is generally smaller than that of the lenticular lens sheet), at which total reflection of light may occur. In the case where the total reflection occurs, the transmittance of the incident light falls down, and the obtained image becomes dark. Further, in the case where the total reflection as described above occurs, the ratio of the intensity of outgoing light to the intensity of incident light deteriorates even though the reflection of outside light is prevented sufficiently, and as a result, the contrast of the obtained image leads to deteriorate.

Further, a method of subjecting the surface of the translucent front panel to a non-reflecting coat process and a hard coating process is proposed in JP-A-7-104385. However, in the case of carrying out such a process, absorption of the incident light may occur in a coat layer (including the non-reflecting coat layer and the hard coat layer). Thus, in a similar manner to the case described above, the ratio of the intensity of outgoing light to the intensity of incident light deteriorates, and as a result, the contrast of the obtained image leads to deteriorate.

### SUMMARY OF THE INVENTION

It is one object of the invention to provide a lens substrate for a transmission screen and/or a rear projection having excellent light use efficiency and that can obtain an image having excellent contrast.

It is another object of the invention to provide a method of manufacturing the lens substrate described above efficiently.

Further, it is yet another object of the invention to provide a transmission screen and a rear projection provided with the lens substrate described above.

In order to achieve the above objects, in one aspect of the invention, the invention is directed to a lens substrate having a first surface and a second surface opposite to the first surface. Light is allowed to enter the lens substrate from the first surface thereof and then exit from the second surface thereof. The lens substrate includes:

a plurality of convex lenses formed on the first surface of the lens substrate from which the light is allowed to enter the lens substrate; and

a total reflection preventing means provided on the second surface of the lens substrate for preventing the light entering the lens substrate from being totally reflected in the vicinity of the second surface thereof.

This makes it possible to provide a lens substrate having excellent light use efficiency and by which an image having excellent contract can be obtained.

In the lens substrate of the invention, it is preferable that the total reflection preventing means is constituted from a plurality of convex curved portions.

This makes it possible to prevent contrast of a projected image from deteriorating due to reflection of outside light or deterioration in light use efficiency thereof more surely.

In the lens substrate of the invention, it is preferable that the radius of curvature of each of the plurality of convex curved portions is in the range of 1.6 to 12,500 μm.

This makes it possible to prevent contrast of a projected image from deteriorating due to reflection of outside light or deterioration in light use efficiency thereof more surely.

In the lens substrate of the invention, it is preferable that, in the case where the radium of curvature of each of the plurality of convex lenses is defined as R₁ (μm) and the radium of curvature of each of the plurality of convex curved portions is defined as R₂ (μm), then R₁ and R₂ satisfy the relation: 3≦R₂/R₁≦10.

This makes it possible to prevent contrast of a projected image from deteriorating due to reflection of outside light or deterioration in light use efficiency thereof more surely.

In the lens substrate of the invention, it is preferable that a ratio of an area where the convex curved portions are formed inside a usable area in which the plurality of convex lenses are formed with respect to the usable area when viewed from above any one of the first and second surfaces of the lens substrate is 50% or more.

This makes it possible to prevent contrast of a projected image from deteriorating due to reflection of outside light or deterioration in light use efficiency thereof more surely.

In the lens substrate of the invention, it is preferable that the apex of each of the convex curved portions and the apex of the corresponding convex lens overlap each other when viewed from above any one of the first and second surfaces of the lens substrate.

This makes it possible to prevent contrast of a projected image from deteriorating due to reflection of outside light or deterioration in light use efficiency thereof more surely. Further, in the case where the lens substrate of the invention is applied to a transmission screen and/or a rear projection, it is possible to improve angle of view characteristics thereof particularly.

In the lens substrate of the invention, it is preferable that the radius of curvature of each of the convex lenses is in the range of 5 to 250 μm.

Thus, in the case where the lens substrate of the invention is applied to a transmission screen and/or a rear projection, it is possible to improve angle of view characteristics thereof particularly.

In the lens substrate of the invention, it is preferable that the lens substrate is constituted from a resin material having an absolute index of refraction in the range of 1.2 to 1.9 as a main material.

This makes it possible to prevent contrast of a projected image from deteriorating due to deterioration in light use efficiency thereof more surely.

In the lens substrate of the invention, it is preferable that each of the convex lenses is a microlens having a substantially circular or elliptic shape when viewed from above any one of the first and second surfaces of the lens substrate.

Thus, in the case where the lens substrate of the invention is applied to a transmission screen and/or a rear projection, it is possible to improve angle of view characteristics thereof particularly.

In another aspect of the invention, the invention is directed to a method of manufacturing a lens substrate having a first surface and a second surface opposite to the first surface. The lens substrate is formed with a plurality of convex lenses on the first surface thereof, and light is allowed to enter the lens substrate from the first surface thereof and then exit from the second surface thereof. The method includes the steps of:

preparing a first substrate formed with a plurality of concave portions on one major surface thereof, each of the plurality of concave portions having a predetermined radius of curvature;

preparing a second substrate formed with a plurality of concave portions on one major surface thereof, each of the plurality of concave portions having a predetermined radius of curvature larger than the radium of curvature of each of the concave portions in the first substrate;

arranging the first and second substrates so that both the one major surfaces thereof on which the plurality of concave portions are respectively formed face with each other to form a space therebetween;

filling the space between the first and second substrates with a resin material having fluidity; and

hardening the filled resin material.

This makes it possible to provide a method of manufacturing a lens substrate having excellent light use efficiency and by which an image having excellent contract can be obtained.

In the method of manufacturing a lens substrate according to the invention, it is preferable that in the first and second substrates arranging step spacers each having an index of refraction nearly equal to that of the resin material are provided between the first and second substrates, and in the resin material hardening step the resin material is hardened while the spacers are left as they are.

Thus, in the case where the lens substrate manufactured using the method of the invention is applied to a transmission screen and/or a rear projection, it is possible to prevent disadvantage such as color heterogeneity from being generated more efficiently.

Further, in yet another aspect of the invention, the invention is directed to a lens substrate. The lens substrate is manufactured using the method defined as described above.

This makes it possible to provide a lens substrate having excellent light use efficiency and by which an image having excellent contract can be obtained.

In still another aspect of the invention, the invention is directed to a transmission screen. The transmission screen of the invention includes:

a Fresnel lens formed with a plurality of concentric prisms on one major surface thereof, the one major surface of the Fresnel lens constituting an emission surface thereof; and

the lens substrate of the invention, the lens substrate being arranged on the side of the emission surface of the Fresnel lens so that the first surface thereof faces the Fresnel lens.

This makes it possible to provide a transmission screen having excellent light use efficiency and by which an image having excellent contract can be obtained.

In yet still another aspect of the invention, the invention is directed to a rear projection. The rear projection of the invention includes the transmission screen defined as described above.

This makes it possible to provide a rear projection having excellent light use efficiency and by which an image having excellent contract can be obtained.

### BRIEF DESCRIPTION OF THE DRAWINGS

The foregoing and other objects, features and advantages of the invention will become more readily apparent from the following detailed description of preferred embodiments of the invention which proceeds with reference to the appending drawings.

FIG. 1 is a longitudinal cross-sectional view which schematically shows a lens substrate (microlens substrate) in a preferred embodiment according to the invention.

FIG. 2 is a plan view of the lens substrate shown in FIG. 1.

FIG. 3 is a longitudinal cross-sectional view which schematically shows a transmission screen provided with the lens substrate (microlens substrate) shown in FIG. 1 in a preferred embodiment according to the invention.

FIG. 4 is a longitudinal cross-sectional view which schematically shows a substrate with concave portions for forming microlenses with the use of manufacturing a microlens substrate.

FIG. 5 is a longitudinal cross-sectional view which schematically shows a method of manufacturing the substrate with concave portions for forming microlenses shown in FIG. 4.

FIG. 6 is a longitudinal cross-sectional view which schematically shows a substrate with concave portions for forming convex curved portions with the use of manufacturing the microlens substrate.

FIG. 7 is a longitudinal cross-sectional view which schematically shows a method of manufacturing the substrate with concave portions for forming convex curved portions shown in FIG. 6.

FIG. 8 is a longitudinal cross-sectional view which schematically shows an example of a method of manufacturing the lens substrate (microlens substrate) shown in FIG. 1.

FIG. 9 is a drawing which schematically shows a rear projection to which the transmission screen of the invention is applied.

### DETAILED DESCRIPTION OF THE INVENTION

Preferred embodiments of a lens substrate, a method of manufacturing a lens substrate, a transmission screen and a rear projection according to the invention will now be described in detail with reference to the appending drawings.

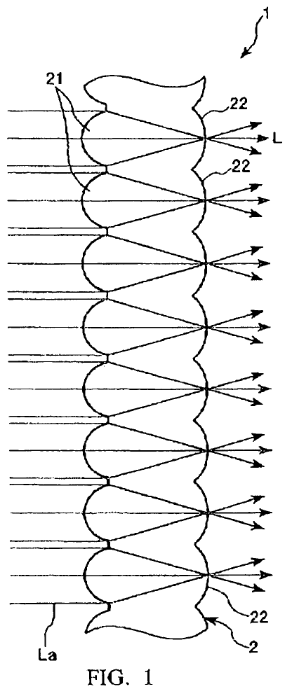

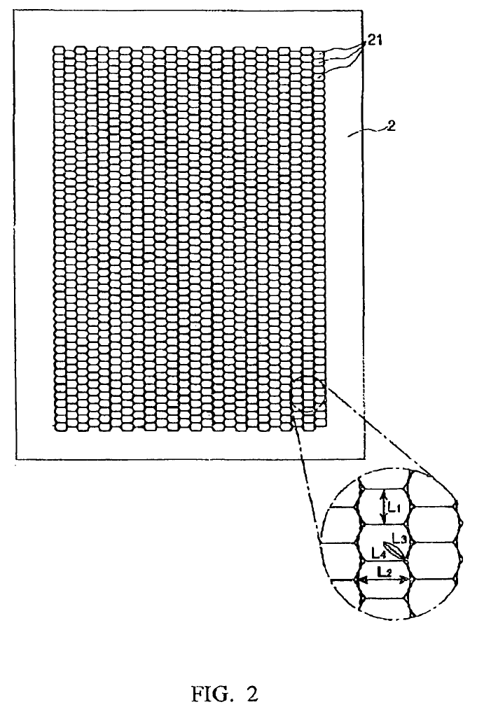

First, the configuration of a lens substrate of the invention will be described. FIG. 1 is a longitudinal cross-sectional view which schematically shows a lens substrate (microlens substrate) 1 in a preferred embodiment according to the invention. FIG. 2 is a plan view of the lens substrate 1 shown in FIG. 1. Now, in the following explanation using FIG. 1, for convenience of explanation, a left side and a right side in FIG. 1 are referred to as a “light incident side (or light incident surface)” and a “light emission side (or light emission surface)”, respectively. In this regard, in the following description, a “light incident side” and a “light emission side” respectively indicate a “light incident side” and a “light emission side” of light for obtaining an image light, and they do not respectively indicate a “light incident side” and a “light emission side” of outside light or the like if not otherwise specified.

The microlens substrate (lens substrate) 1 is a member that is included in a transmission screen 10 (will be described later). As shown in FIG. 1, the microlens substrate 1 has a main substrate 2 provided with a plurality of microlenses (convex lenses) 21 at one major surface (first surface) thereof. Further, the microlens substrate 1 has a plurality of minute convex curved portions 22 on the main substrate 2 thereof at the side of the other major surface (second surface that constitutes a light emission surface) opposite to the surface on which the plurality of microlenses 21 are formed. The constituent material of the main substrate 2 is not particularly limited, but the main substrate 2 is formed of a resin material as a main material. The resin material is a transparent material having a predetermined index of refraction.

As for the concrete constituent material of the main substrate 2, for example, polyolefin such as polyethylene, polypropylene, ethylene-propylene copolymer, ethylene-vinyl acetate copolymer (EVA) and the like, cyclic polyolefin, denatured polyolefin, polyvinyl chloride, polyvinylidene chloride, polystyrene, polyamide (such as nylon 6, nylon 46, nylon 66, nylon 610, nylon 612, nylon 11, nylon 12, nylon 6-12, nylon 6-66), polyimide, polyamide-imide, polycarbonate (PC), poly-(4-methylpentene-1), ionomer, acrylic resin, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyester such as polyethylene terephthalate (PET), polybutylene terephthalate (PBT), and polycyclohexane terephthalate (PCT), polyether, polyether ketone (PEK), polyether ether ketone (PEEK), polyether imide, polyacetal (POM), polyphenylene oxide, denatured polyphenylene oxide, polysulfone, polyether sulfone, polyphenylene sulfide, polyarylate, liquid crystal polymer such as aromatic polyester, fluoro resins such as polytetrafluoroethylene (PTFE), polyfluorovinylidene and the like, various thermoplastic elastomers such as styrene based elastomer, polyolefin based elastomer, polyvinylchloride based elastomer, polyurethane based elastomer, polyester based elastomer, polyamide based elastomer, polybutadiene based elastomer, trans-polyisoprene based elastomer, fluorocarbon rubber based elastomer, chlorinated polyethylene based elastomer and the like, epoxy resins, phenolic resins, urea resins, melamine resins, unsaturated polyester, silicone based resins, urethane based resins, and the like; and copolymers, blended bodies and polymer alloys and the like having at least one of these materials as a main ingredient may be mentioned. Further, in this invention, a mixture of two or more kinds of these materials may be utilized (for example, a blended resin, a polymer alloy, a laminated structure comprised of two or more layers using two or more of the materials mentioned above).

The resin material constituting the main substrate 2 generally has an absolute index of refraction more than each of those of various gases (that is, atmosphere at which the microlens substrate 1 is used). It is preferable that the concrete absolute index of refraction of the resin material is in the range of 1.2 to 1.9. More preferably it is in the range of 1.35 to 1.75, and further more preferably it is in the range of 1.45 to 1.60. In the case where the absolute index of refraction of the resin material has a predetermined value within the above range, it is possible to further improve the angle of view characteristics of a transmission screen 10 provided with the microlens substrate 1 while keeping the light use efficiency of the transmission screen 10.

The microlens substrate 1 is provided with the plurality of microlenses 21 each having a convex surface as a convex lens on the side of the light incident surface (that is, first surface) thereof from which the light is allowed to enter the microlens substrate 1. The shape of each of the microlenses 21 when viewed from above the light incident surface of the microlens substrate 1 (hereinafter, referred to simply as a “shape of the microlens 21”) is not particularly limited, but it is preferable that the shape of the microlens 21 is a substantially circular or elliptic shape (in this case, such a shape includes a substantial bale shape and a shape in which the top and bottom portions of a substantially circular shape are cut). In the case where the shape of the microlens 21 is a substantially circular or elliptic shape, it is possible to further improve the angle of view characteristics of the transmission screen 10 provided with the microlens substrate 1. In particular, in this case, it is possible to improve the angle of view characteristics in both the horizontal and vertical directions of the transmission screen 10 provided with the microlens substrate 1.

In the case where the shape of the microlens 21 is a substantially elliptic shape, the length (or pitch) in a short axis (or minor axis) direction thereof is defined as L₁ (μm) and the length (or pitch) in a long axis (or major axis) direction thereof is defined as L₂ (μm), it is preferable that the ratio of L₁/L₂ is in the range of 0.10 to 0.99 (that is, it is preferable that L₁ and L₂ satisfy the relation: 0.10≦L₁/L₂≦0.99). More preferably it is in the range of 0.50 to 0.95, and further more preferably it is in the range of 0.60 to 0.80. By restricting the ratio of L₁/L₂ within the above range, the effect described above can become apparent.

It is preferable that the diameter of each of the microlenses 21 (the length thereof in the minor axis direction in the case where the shape of the microlens 21 is a substantially elliptic shape) is in the range of 10 to 500 μm. More preferably it is in the range of 30 to 300 μm, and further more preferably it is in the range of 50 to 100 μm. By restricting the diameter of each of the microlenses 21 within the above range, it is possible to further enhance the productivity of the microlens substrate 1 (including the transmission screen 10) while maintaining sufficient resolution in the image projected on the transmission screen 10. In this regard, it is preferable that the pitch between adjacent microlenses 21 in the microlens substrate 1 is in the range of 10 to 500 μm. More preferably the pitch is in the range of 30 to 300 μm, and further more preferably the pitch is in the range of 50 to 100 μm.

Further, it is preferable that the radius of curvature of each of the microlenses 21 (the radius of curvature in the minor axis direction thereof in the case where the shape of the microlens 21 is a substantially elliptic shape) is in the range of 5 to 150 μm. More preferably it is in the range of 15 to 150 μm, and further more preferably it is in the range of 25 to 50 μm. By restricting the radius of curvature of the microlens 21 within the above range, it is possible to improve the angle of view characteristics of the transmission screen 10 provided with the microlens substrate 1. In particular, in this case, it is possible to improve the angle of view characteristics in both the horizontal and vertical directions of the transmission screen 10 provided with the microlens substrate 1.

Moreover, an arrangement pattern of the microlenses 21 is not particularly limited. The arrangement pattern may be either an arrangement pattern in which the microlenses 21 are arranged in a regular manner (for example, a lattice-shaped manner, honeycomb-shaped manner, houndstooth check manner) or an arrangement pattern in which the microlenses 21 are arranged in an optically random manner (the microlenses 21 are randomly arranged with each other when viewed from above the light incident surface (one major surface) of the microlens substrate 1). However, it is preferable that the microlenses 21 are arranged in a regular houndstooth check manner as shown in FIG. 2. By arranging the microlenses 21 in such a regular houndstooth check manner, it is possible to efficiently prevent interference of the light to a light valve of a liquid crystal or the like and a Fresnel lens from being generated, and to prevent moire from being generated more efficiently. In addition, it is possible to bring out the lens effect fully. Further, in the case where the microlenses 21 are arranged in such a regular houndstooth check manner, it is possible to prevent interference of the light to a light valve of a liquid crystal or the like and a Fresnel lens from being generated more efficiently, and therefore it is possible to prevent moire from being generated almost completely. This makes it possible to obtain an excellent transmission screen 10 having a high display quality.

Further, it is preferable that the ratio of an area (projected area) occupied by all the microlenses (convex lenses) 21 in a usable area where the microlenses 21 are formed with respect to the entire usable area is 90% or more when viewed from above the light incident surface of the microlens substrate 1 (that is, a direction shown in FIG. 2). More preferably the ratio is 96% or more. In the case where the ratio of the area occupied by all the microlenses (convex lenses) 21 in the usable area with respect to the entire usable area is 90% or more, it is possible to reduce straight light passing through an area other than the area where the microlenses 21 reside, and this makes it possible to enhance the light use efficiency of the transmission screen 10 provided with the microlens substrate 1 further. In this regard, in the case where the length of one microlens 21 in a direction from the center of the one microlens 21 to the center of a non-formed area on which the four adjacent microlenses 2 including the one microlens 2 are not formed is defined as L₃ (μm) and the length between the center of the one microlens 21 and the center of the non-formed area is defined as L₄ (μm), the ratio of an area (projected area) occupied by all the microlenses (convex lenses) 21 in a usable area where the microlenses 21 are formed with respect to the entire usable area can be approximated by the ratio of the length of the line segment L₃ (μm) to the length of the line segment L₄ (μm) (that is, L₃/L₄×100 (%)) (see FIG. 2).

In addition, a plurality of minute convex curved portions 22 are provided on the side of the light emission surface (second surface) of the microlens substrate 1. The plurality of convex curved portions 22 function as total reflection preventing means. The radius of curvature of each of the plurality of convex curved portions 22 is larger than the radius of curvature of each of the microlenses 21 described above. By providing such convex curved portions 22 on the second surface of the microlens substrate 1, it is possible to prevent light entering the microlens substrate 1 from the light incident surface (first surface) of the microlens substrate 1 from being totally reflected in the vicinity of the second surface thereof efficiently, and this makes it possible to make the light entering the microlens substrate 1 penetrate the inside of the microlens substrate 1 efficiently. Further, it is possible to diffusely reflect outside light that may enter the microlens substrate 1 from the light emission surface (second surface) thereof. As a result, contrast of the obtained image can become particularly excellent.

The shape of each of the convex curved portions 22 when viewed from above the light emission surface of the microlens substrate 1 (hereinafter, referred to simply as a “shape of the convex curved portion 22”) is not particularly limited, but it is preferable that the shape of the convex curved portion 22 is a shape corresponding to the shape of the microlens 21 (that is, a similarity shape). More specifically, in the case where the shape of the microlens 21 is a substantially circular shape, it is preferable that the shape of the convex curved portion 22 is a substantially circular shape. Further, in the case where the shape of the microlens 21 is a substantially elliptic shape, it is preferable that the shape of the convex curved portion 22 is a substantially elliptic shape (that is, the ratio of the minor axis length and the major axis length of the convex curved portion 22 is substantially the same as that of the microlens 21). This makes it possible to prevent contrast of a projected image from deteriorating due to deterioration in light transmission of the incident light thereto more surely.

Further, it is preferable that the microlenses 21 and the convex curved portions 22 are arranged so that the apex (that is, the center) of each of the convex curved portions 22 and the apex (that is, the center) of the corresponding microlens 21 overlap each other when viewed from above any one of the first and second surfaces (that is, the light incident surface and light emission surface thereof) of the microlens substrate 1. This makes it possible to prevent contrast of a projected image from deteriorating due to deterioration in light transmission of the incident light thereto more surely.

It is preferable that the diameter of each of the convex curved portions 22 (the length thereof in the minor axis direction in the case where the shape of the convex curved portion 22 is a substantially elliptic shape) is in the range of 3.3 to 25,000 μm. More preferably it is in the range of 10 to 5,000 μm, and further more preferably it is in the range of 30 to 3,000 μm. Most preferably it is in the range of 40 to 2,000 μm. In the case where the diameter of each of the convex curved portions 22 is restricted within the above range, it is possible to prevent the light transmission of the incident light thereto from being deteriorated more efficiently, and it is possible to diffusely reflect outside light that may enter the microlens substrate 1 from the light emission surface (second surface) thereof. As a result, contrast of the obtained image can become particularly excellent. In this regard, it is preferable that the pitch between adjacent convex curved portions 22 in the microlens substrate 1 is in the range of 3.3 to 25,000 μm. More preferably the pitch is in the range of 10 to 500 μm, and further more preferably the pitch is in the range of 30 to 300 μm. Most preferably it is in the range of 50 to 100 μm.

Further, it is preferable that the radius of curvature of each of the convex curved portions 22 (the radius of curvature in the minor axis direction thereof in the case where the shape of the convex curved portion 22 is a substantially elliptic shape) is in the range of 15 to 2,500 μm. More preferably it is in the range of 18 to 1,500 μm, and further more preferably it is in the range of 20 to 750 μm. In the case where the radius of curvature of each of the convex curved portions 22 is restricted within the above range, it is possible to prevent the light transmission of the incident light thereto from being deteriorated more efficiently, and it is possible to diffusely reflect outside light that may enter the microlens substrate 1 from the light emission surface (second surface) thereof. As a result, contrast of the obtained image can become particularly excellent.

Further, in the case where the radium of curvature of each of the plurality of microlenses 21 is defined as R₁ (μm) and the radium of curvature of each of the plurality of convex curved portions 22 is defined as R₂ (μm), it is preferable that R₁ and R₂ satisfy the relation: 3≦R₂/R₁≦100. More preferably R₁ and R₂ satisfy the relation: 5≦R₂/R₁≦50, and further more preferably R₁ and R₂ satisfy the relation: 8≦R₂/R₁≦25. Most preferably R₁ and R₂ satisfy the relation: 10≦R₂/R₁≦20. In the case where R₁ and R₂ satisfy such a relation, it is possible to efficiently prevent light transmission of the incident light from deteriorating, and it is possible to diffusely reflect outside light that may enter the microlens substrate 1 from the light emission surface (second surface) thereof. As a result, contrast of the obtained image can become particularly excellent.

Moreover, an arrangement pattern of the convex curved portions 22 is not particularly limited. The arrangement pattern may be either an arrangement pattern in which the microlenses 21 are arranged in a regular manner (for example, a lattice-shaped manner, honeycomb-shaped manner, houndstooth check manner) or an arrangement pattern in which the microlenses 21 are arranged in an optically random manner (the microlenses 21 are randomly arranged with each other when viewed from above the light incident surface (one major surface) of the microlens substrate 1). However, it is preferable that the convex curved portions 22 are arranged so that the arrangement pattern thereof corresponds to the arrangement pattern of the microlenses 21. This makes it possible to prevent the contrast of a projected image from deteriorating due to deterioration in the light transmission of the incident light more surely.

Furthermore, it is preferable that the ratio of an area (projected area) occupied by all the convex curved portions 22 in a usable area where the microlenses 21 are formed with respect to the entire usable area is 50% or more when viewed from above the light incident surface or light emission surface of the microlens substrate 1. More preferably the ratio is 90% or more, and further more preferably the ratio is 96% or more. In the case where the ratio of the area occupied by all the convex curved portions 22 in the usable area with respect to the entire usable area is 50% or more, it is possible to prevent the contrast of a projected image from deteriorating due to reflection of outside light more surely.

In addition, the microlens substrate 1 may be provided with a light shielding portion such as black matrix (not shown in the drawings). This makes it possible to prevent the contrast of a projected image from deteriorating due to reflection of outside light more surely.

Next, a transmission screen 10 provided with the microlens substrate 1 as described above will now be described.

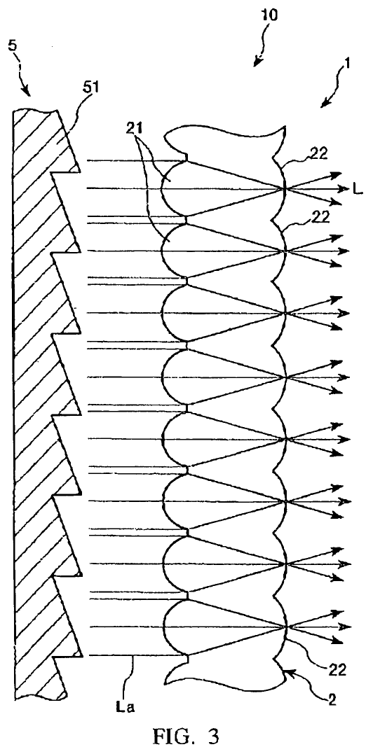

FIG. 3 is a longitudinal cross-sectional view which schematically shows a transmission screen 10 provided with the lens substrate (microlens substrate) 1 shown in FIG. 1 in a preferred embodiment according to the invention. Now, in the following explanation using FIG. 3, for convenience of explanation, a left side and a right side in FIG. 3 are referred to as a “light incident side (or light incident surface)” and a “light emission side (or light emission surface)”, respectively. In this regard, in the following description, a “light incident side” and a “light emission side” respectively indicate a “light incident side” and a “light emission side” of light for obtaining an image light, and they do not respectively indicate a “light incident side” and a “light emission side” of outside light or the like if not otherwise specified. As shown in FIG. 3, the transmission screen 10 is provided with a Fresnel lens 5 and the microlens substrate 1 described above. The Fresnel lens 5 is arranged on the side of the light incident surface of the microlens substrate 1 (that is, on the incident side of light for an image), and the transmission screen 10 is constructed so that the light that has been transmitted by the Fresnel lens 5 enters the microlens substrate 1.

The Fresnel lens 5 is provided with a plurality of prisms that are formed on a light emission surface of the Fresnel lens 5 in a substantially concentric manner. The Fresnel lens 5 deflects the light for a projected image from a projection lens (not shown in the drawings), and outputs parallel light La that is parallel to the perpendicular direction of the major surface of the microlens substrate 1 to the side of the light incident surface of the microlens substrate 1.

In the transmission screen 10 constructed as described above, the light from the projection lens is deflected by the Fresnel lens 5 to become the parallel light La. Then, the parallel light La enters the microlens substrate 1 from the light incident surface on which the plurality of microlenses 21 are formed to be condensed by each of the microlenses 21 of the microlens substrate 1, and the condensed light then diffuses after the condensed light is focused. At this time, the light entering the microlens substrate 1 penetrates through the microlens substrate 1 with sufficient transmittance and is then diffused, whereby an observer (viewer) of the transmission screen 10 observes (watches) the light as a flat image.

Next, an example of a method of manufacturing the microlens substrate 1 described above will now be described.

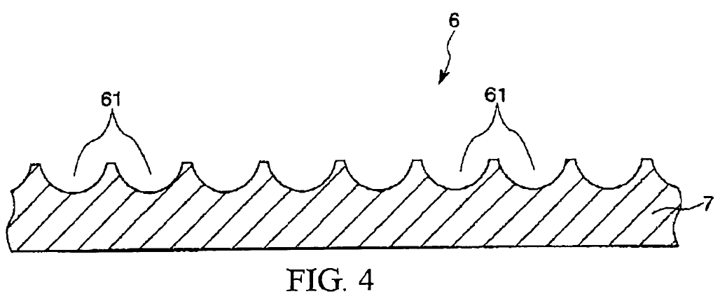

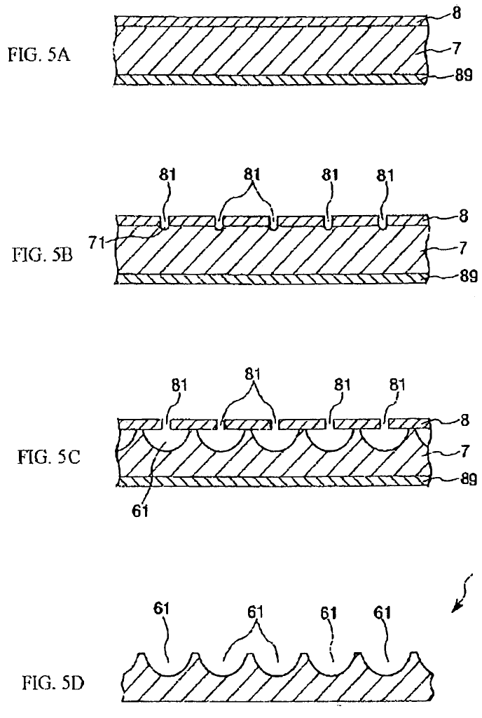

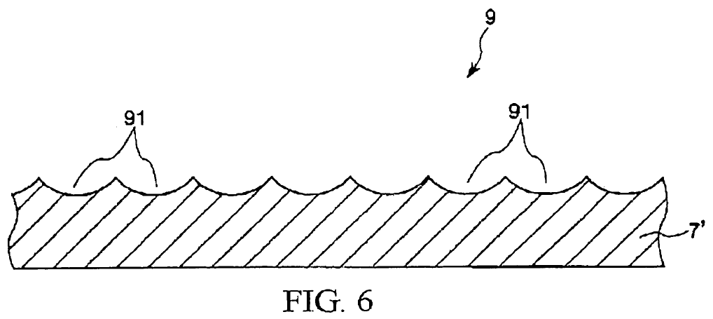

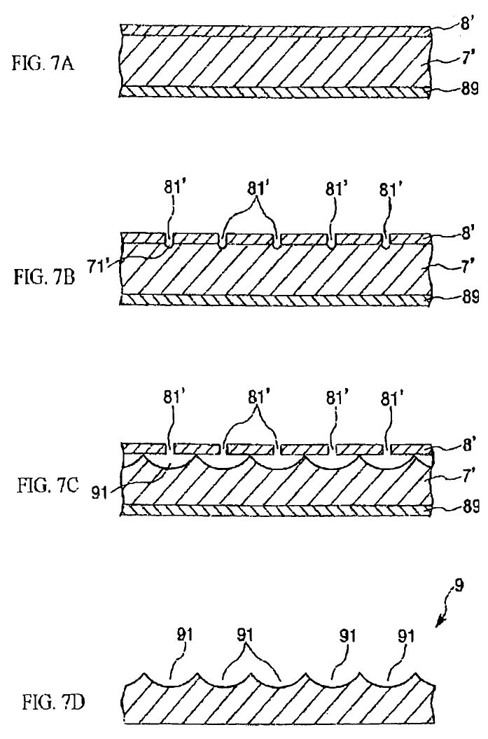

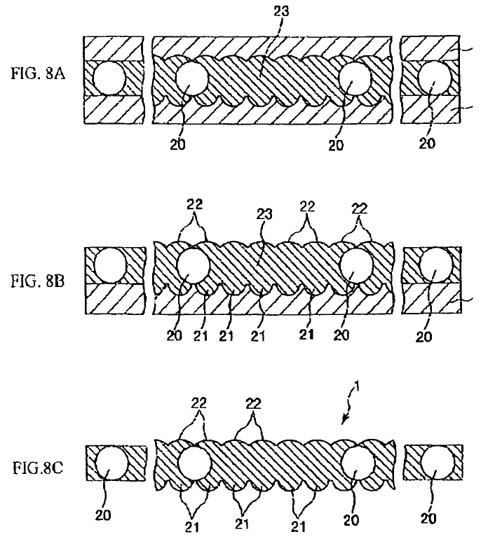

FIG. 4 is a longitudinal cross-sectional view which schematically shows a substrate 6 with concave portions for forming microlenses 21 with the use of manufacturing the microlens substrate 1. FIG. 5 is a longitudinal cross-sectional view which schematically shows a method of manufacturing the substrate 6 with concave portions for forming microlenses 21 shown in FIG. 4. FIG. 6 is a longitudinal cross-sectional view which schematically shows a substrate 9 with concave portions for forming the convex curved portions 22 with the use of manufacturing the microlens substrate 1. FIG. 7 is a longitudinal cross-sectional view which schematically shows a method of manufacturing the substrate 9 with concave portions for forming convex curved portions 22 shown in FIG. 6. FIG. 8 is a longitudinal cross-sectional view which schematically shows an example of a method of manufacturing the microlens substrate shown in FIG. 1. In this regard, in the following description, the lower side and upper side in FIG. 8 are referred to as a “light incident side (or light incident surface)” and a “light emission side (or light emission surface)”, respectively.

A plurality of concave portions for forming microlenses 21 are actually formed on a substrate in manufacturing the substrate 6 with concave portions for forming microlenses 21, and a plurality of convex lenses (microlenses 21) are actually formed on a substrate in manufacturing the microlens substrate 1. However, in order to make the explanation understandable, a part of each of the substrate 6 with concave portions for forming microlenses 21 and the microlens substrate 1 is shown so as to be emphasized in FIGS. 4 and 5. Similarly, a plurality of concave portions for forming convex curved portions 22 are actually formed on a substrate in manufacturing the substrate 9 with concave portions for forming convex curved portions 22, and a plurality of convex curved portions 22 are actually formed on a substrate in manufacturing the microlens substrate 1. However, in order to make the explanation understandable, a part of each of the substrate 9 with concave portions for forming convex curved portions 22 and the microlens substrate 1 is shown so as to be emphasized in FIGS. 6 and 7.

A structure of the substrate 6 with concave portions for forming microlenses 21 used to manufacture the microlens substrate 1 and a method of manufacturing the same, and a structure of the substrate 9 with concave portions for forming convex curved portions 22 used to manufacture the microlens substrate 1 and a method of manufacturing the same will be described prior to the description of a method of manufacturing the microlens substrate 1.

The structure of the substrate 6 with concave portions for forming microlenses 21 used to manufacture the microlens substrate 1 and a method of manufacturing the same will be first described.

As shown in FIG. 4, a substrate 6 with concave portions for forming microlenses 21 has a plurality of concave portions (for forming microlenses 21) 61 arranged thereon in a regular houndstooth check manner. By using such a substrate 6 with concave portions for forming microlenses 21, it is possible to obtain a microlens substrate 1 on which a plurality of microlenses 21 are arranged in regular houndstooth check manner as described above.

Next, the method of manufacturing the substrate 6 with concave portions for forming microlenses 21 will be described with reference to FIG. 5. In this regard, although a large number of concave portions for forming microlenses 21 are actually formed on the substrate, only a part of them will be exaggeratedly shown in order to simplify the explanation thereof.

First, a substrate 7 is prepared in manufacturing the substrate 6 with concave portions for forming microlenses 21. It is preferable that a substrate having a uniform thickness without flexure and blemishes is used for the substrate 7. Further, it is also preferable that a substrate with a surface cleaned by washing or the like is used for the substrate 7.

Although soda-lime glass, crystalline glass, quartz glass, lead glass, potassium glass, borosilicate glass, alkali-free glass or the like may be mentioned as for a constituent material for the substrate 7, soda-lime glass and crystalline glass (for example, neoceram or the like) are preferable among them. By the use of soda-lime glass, crystalline glass or alkali-free glass, it is easy to process the material for the substrate 7, and it is advantageous from the viewpoint of a manufacturing cost of the substrate 6 with concave portions for forming microlenses 21 because soda-lime glass or crystalline glass is relatively inexpensive.

<A1> As shown in FIG. 5A, a mask 8 is formed on the surface of the prepared substrate 7 (mask formation process). Then, a back surface protective film 89 is formed on the back surface of the substrate 7 (that is, the surface side opposite to the surface on which the mask 8 is formed). Needless to say, the mask 8 and the back surface protective film 89 may be formed simultaneously. It is preferable that the mask 8 permits initial holes 81 (will be described later) to be formed therein by means of irradiation with laser beams or the like, and has resistance to etching at an etching process (will be described later). In other words, it is preferable that the mask 8 is constituted so that an etching rate for the mask 8 is nearly equal to or smaller than that for the substrate 7.

From such a viewpoint, for example, metals such as Cr, Au, Ni, Ti, Pt, and the like, metal alloys containing two or more kinds of metals selected from these metals, oxides of these metals (metal oxides), silicon, resins, and the like may be mentioned as a constituent material for the mask 8. Alternatively, the mask 8 may be given to a laminated structure by a plurality of layers formed of different materials such as a Cr/Au or chromium oxide/Cr laminate.

The method of forming the mask 8 is not particularly limited. In the case where the mask 8 is constituted from any of metal materials (including metal alloys) such as Cr and Au or metal oxides such as chromium oxide, the mask 8 can be suitably formed by means of an evaporation method, a sputtering method, or the like, for example. On the other hand, in the case where the mask 8 is formed of silicon, the mask 8 can be suitably formed by means of a sputtering method, a CVD method, or the like, for example.

In the case where the mask 8 is formed of chromium oxide or chromium as a main material thereof, the initial holes 81 can be easily formed by an initial hole formation process (will be described later), and the substrate 7 can be protected at the etching process more surely. Further, in the case where the mask 8 is formed of chromium oxide or chromium as a main material thereof, a solution of ammonium hydrogen difluoride (NH₄HF₂), for example, may be used as an etchant at the etching process (will be described later). Since a solution containing ammonium hydrogen difluoride is not poison, it is possible to prevent its influence on human bodies during work and on the environment more surely.

Although the thickness of the mask 8 also varies depending upon the material constituting the mask 8, it is preferable that the thickness of the mask 8 is in the range of 0.01 to 2.0 μm, and more preferably it is in the range of 0.03 to 0.2 μm. If the thickness of the mask 8 is below the lower limit given above, there is a possibility to deform the shapes of the initial holes 81 formed at the initial hole formation process (will be described later). In addition, there is a possibility that sufficient protection for the masked portion of the substrate 7 cannot be obtained during a wet etching process at the etching step (will be described later). On the other hand, if the thickness of the mask 8 is over the upper limit given above, in addition to the difficulty in formation of the initial holes 81 that penetrate the mask 8 at the initial hole formation process (will be described later), there will be a case in which the mask 8 tends to be easily removed due to internal stress thereof depending upon the constituent material or the like of the mask 8.

The back surface protective film 89 is provided for protecting the back surface of the substrate 7 at the subsequent processes. Erosion, deterioration or the like of the back surface of the substrate 7 can be suitably prevented by means of the back surface protective film 89. Since the back surface protective film 89 is formed using the same material as the mask 8, it may be provided in a manner similar to the formation of the mask 8 simultaneously with the formation of the mask 8.

<A2> Next, as shown in FIG. 5B, the plurality of initial holes 81 that will be utilized as mask openings at the etching process (will be described later) are formed in the mask 8 (initial hole formation process). The initial holes 81 may be formed in any method, but it is preferable that the initial holes 81 are formed by the physical method or the irradiation with laser beams. This makes it possible to manufacture the substrate 6 with concave portions for forming microlenses 21 at high productivity. In particular, the concave portions can be easily formed on a relatively large-sized substrate. As for the physical methods of forming the initial holes 81, for example, etching, pressing, dot printing, blast processing such as shot blast, sand blast or the like, tapping, rubbing, or the like may be mentioned.

Further, in the case where the initial holes 81 are formed by means of the irradiation with laser beams, the kind of laser beam to be used is not particularly limited, but a ruby laser, a semiconductor laser, a YAG laser, a femtosecond laser, a glass laser, a YVO₄ laser, a Ne—He laser, an Ar laser, a carbon dioxide laser, an excimer laser or the like may be mentioned. Moreover, a waveform of a laser such as SHG (second-harmonic generation), THG (third-harmonic generation), FHG (fourth-harmonic generation) or the like may be utilized. In the case where the initial holes 81 are formed by means of the irradiation of laser beams, it is possible to easily and precisely control the size of the initial holes 81, distance between adjacent initial holes 81, or the like. Furthermore, in the case where the initial holes 81 are formed by the irradiation with laser beams, by controlling irradiation conditions for the laser beams, it is possible not only to form the initial holes 81 without forming initial concave portions 71 (will be described later), but also to form the initial concave portions 71 having a little variation in shapes, sizes and depths thereof as well as those of initial holes 81 easily and surely.

It is preferable that the initial holes 81 are formed uniformly on the entire surface of the mask 8. Further, it is preferable that the initial holes 81 are formed in such a manner in which small holes are arranged at predetermined regular intervals so that there is no flat portion on the surface of the substrate 7 to be formed, and so that the surface of the substrate 7 is covered with concave portions 81 with almost no space when subjecting the substrate 7 with the mask 8 to an etching process at step <A3> (will be described later).

More specifically, for example, it is preferable that the shape of each of the formed initial holes 81 when viewed from above one major surface of the substrate 7 on which the mask 8 has been formed is a substantially elliptic shape and each of the initial holes 81 has the average diameter in the range of 2 to 10 μm. Furthermore, it is preferable that the initial holes 81 are formed on the mask 8 at the rate of 1,000 to 1,000,000 holes per square centimeter (cm²), and more preferably they are formed at the rate of 10,000 to 500,000 holes per square centimeter (cm²). In this regard, needless to say, the shape of each of the initial holes 81 is not limited to the substantially elliptic shape.

When the initial holes 81 are formed in the mask 8, as shown in FIG. 5B, the initial concave portions 71 may also be formed in the substrate 7 by removing parts of the surface of the substrate 7 in addition to the initial holes 81. This makes it possible to increase contact area of the substrate 7 with the etchant when subjecting the substrate 7 with the mask 8 to the etching process (will be described later), whereby erosion can be started suitably. Further, by adjusting the depth of each of the initial concave portions 71, it is also possible to adjust the depth of the concave portions 61 (that is, the maximum thickness of the lens (microlens 21)). Although the depth of each of the initial concave portions 71 is not particularly limited, it is preferable that it is 5.0 m or less, and more preferably it is in the range of about 0.1 to 0.5 μm. In the case where the formation of the initial holes 81 is carried out by means of the irradiation with laser beams, it is possible to surely reduce variation in the depth of each of the plurality of initial concave portions 71 formed together with the initial holes 81. This makes it possible to reduce variation in the depth of each of the concave portions 61 constituting a substrate 6 with concave portions for forming microlenses 21, and therefore it is possible to reduce variation in the size and shape of each of the microlenses 21 in the microlens substrate 1 obtained finally. As a result, it is possible to reduce variation in the diameter, the focal distance, and the thickness of the lens of each of the microlenses 21, in particular.

Further, other than by means of the physical method or the irradiation with laser beams, the initial holes 81 may be formed in the formed mask 8 by, for example, previously arranging foreign objects on the substrate 7 with a predetermined pattern when the mask 8 is formed on the substrate 7, and then forming the mask 8 on the substrate 7 with the foreign objects to form defects in the mask 8 by design so that the defects are utilized as the initial holes 81.

In this way, in the invention, by forming the initial holes 81 in the mask 8 by means of the physical method or the irradiation with laser beams, it is possible to form openings (initial holes 81) in the mask 8 easily and inexpensively compared with the formation of the openings in the mask 8 by means of a conventional photolithography method. Further, according to the physical method or the irradiation with laser beams, it is possible to deal with a large-sized substrate easily.

<A3> Next, as shown in FIG. 5C, a large number of concave portions 61 are formed in the substrate 7 by subjecting the substrate 7 to the etching process using the mask 8 in which the initial holes 81 are formed (etching process). The etching method is not particularly limited, and as for the etching method, a wet etching process, a dry etching process and the like may be mentioned, for example. In the following explanation, the case of using the wet etching process will be described as an example.

By subjecting the substrate 7 covered with the mask 8 in which the initial holes 81 are formed to the wet etching process, as shown in FIG. 5C, the substrate 7 is eroded from the portions where no mask 8 is present, whereby a large number of concave portions 61 are formed in the substrate 7. As mentioned above, since the initial holes 81 formed in the mask 8 are arranged in a houndstooth check manner, the concave portions 61 to be formed are also arranged on the surface of the substrate 7 in a houndstooth check manner.

Further, in the present embodiment, the initial concave portions 71 are formed on the surface of the substrate 7 when the initial holes 81 are formed in the mask 8 at step <A2>. This makes the contact area of the substrate 7 with the etchant increase during the etching process, whereby erosion can be made to start suitably. Moreover, the concave portions 61 can be formed suitably by employing the wet etching process. In the case where an etchant containing hydrofluoric acid (hydrogen fluoride) (that is, hydrofluoric acid-based etchant) is utilized for an etchant, for example, the substrate 7 can be eroded more selectively, and this makes it possible to form the concave portions 61 suitably.

In the case where the mask 8 is mainly constituted from chromium (that is, the mask 8 is formed of a material containing Cr as a main material thereof), a solution of ammonium hydrogen difluoride is particularly suited as a hydrofluoric acid-based etchant. Since a solution containing ammonium hydrogen difluoride (4% by weight or less aqueous solution thereof) is not poison, it is possible to prevent its influence on human bodies during work and on the environment more surely. Further, in the case where the solution of ammonium hydrogen difluoride is used as an etchant, for example, hydrogen peroxide may be contained in the etchant. This makes it possible to accelerate the etching speed.

Further, the wet etching process can be carried out with simpler equipment than that in the dry etching process, and it allows the processing for a larger number of substrates 7 at a time. This makes it possible to enhance productivity of the substrates 6, and it is possible to provide the substrate 6 with concave portions for forming microlenses 21 at a lower cost.

<A4> Next, the mask 8 is removed as shown in FIG. 5D (mask removal process). At this time, the back surface protective film 89 is also removed along with the mask 8. In the case where the mask 8 is constituted from chromium as a main material thereof, the removal of the mask 8 can be carried out by means of an etching process using a mixture of ceric ammonium nitrate and perchloric acid, for example.

As a result of the processing in the above, as shown in FIGS. 5D and 4, a substrate 6 with concave portions for forming microlenses 21 in which a large number of concave portions 61 are formed in the substrate 7 in a houndstooth check manner is obtained.

The method of forming the plurality of concave portions 61 in the substrate 7 in a houndstooth check manner is not particularly limited. In the case where the concave portions 61 are formed by means of the method mentioned above, that is, the method of forming the concave portions 61 in the substrate 7 by forming the initial holes 81 in the mask 8 by means of the physical method or the irradiation with laser beams and then subjecting the substrate 7 to the etching process using the mask 8, it is possible to obtain the following effects.

Namely, by forming the initial holes 81 in the mask 8 by means of the physical method or the irradiation with laser beams, it is possible to form openings (initial holes 81) in a predetermined pattern in the mask 8 easily and inexpensively compared with the case of forming the openings in the mask 8 by means of the conventional photolithography method. This makes it possible to enhance productivity of the substrate 6 with concave portions for forming microlenses 21, whereby it is possible to provide the substrate 6 with concave portions for forming microlenses 21 at a lower cost.

Further, according to the method as described above, it is possible to carry out the processing for a large-sized substrate easily. Also, according to the method, in the case of manufacturing such a large-sized substrate, there is no need to bond a plurality of substrates as the conventional method, whereby it is possible to eliminate the appearance of seams of bonding. This makes it possible to manufacture a high quality large-sized substrate 6 with concave portions for forming microlenses 21 (that is, microlens substrate 1) by means of a simple method at a low cost.

In particular, in the case of forming the initial holes 81 by means of the irradiation of laser beams, it is possible to control the shape and size of each of the initial holes 81 to be formed, arrangement thereof, and the like easily and surely.

Moreover, after the mask 8 is removed at step <A4>, a new mask may be formed on the substrate 7, and then a series of processes including the mask formation process, the initial hole formation process, the wet etching process and the mask removal process may be repeated. This makes it possible to obtain the substrate 6 with concave portions for forming microlenses 21 in which the concave portions 61 are formed densely.

Next, the structure of the substrate 9 with concave portions for forming convex curved portions 22 used to manufacture the microlens substrate 1 and a method of manufacturing the same will be described.

As shown in FIG. 6, a substrate 9 with concave portions for forming convex curved portions 22 has a plurality of concave portions (for convex curved portions 22) 91 arranged thereon in a regular houndstooth check manner. By using such a substrate 9 with concave portions for forming convex curved portions 22, it is possible to obtain a microlens substrate 1 on which a plurality of convex curved portions 22 are arranged in regular houndstooth check manner as described above.

Next, the method of manufacturing the substrate 9 with concave portions for forming convex curved portions 22 will be described with reference to FIG. 5. In this regard, although a large number of concave portions for forming convex curved portions 22 are actually formed on the substrate, only a part of them will be exaggeratedly shown in order to simplify the explanation thereof.

First, a substrate 7′ is prepared in manufacturing the substrate 9 with concave portions for forming convex curved portions 22. The substrate 7′ is similar to the substrate 7 described above (the substrate 7 for manufacturing the substrate 6 with concave portions for forming microlenses 21). It is preferable that a substrate having a uniform thickness without flexure and blemishes is used for the substrate 7′. Further, it is also preferable that a substrate with a surface cleaned by washing or the like is used for the substrate 7′.

It is preferable that a constituent material for the substrate 7′ is similar to that for the substrate 7 described above (the substrate 7 for manufacturing the substrate 6 with concave portions for forming microlenses 21).

<B1> As shown in FIG. 7A, a mask 8′ is formed on the surface of the prepared substrate 7′ (mask formation process). Then, a back surface protective film 89′ is formed on the back surface of the substrate 7′ (that is, the surface side opposite to the surface on which the mask 8′ is formed). Needless to say, the mask 8′ and the back surface protective film 89′ may be formed simultaneously. It is preferable that the mask 8′ permits initial holes 81′ (will be described later) to be formed therein by means of irradiation with laser beams or the like, and has resistance to etching at an etching process (will be described later). In other words, it is preferable that the mask 8′ is constituted so that an etching rate for the mask 8′ is nearly equal to or smaller than that for the substrate 7.

From such a viewpoint, it is preferable that a constituent material for the mask 8′ is similar to that for the mask 8 described above (the mask 8 for manufacturing the substrate 6 with concave portions for forming microlenses 21), for example. The method of forming the mask 8′ is not particularly limited. It is also preferable that the method of forming the mask 8′ is similar to the method of forming the mask 8 described above (the mask 8 for manufacturing the substrate 6 with concave portions for forming microlenses 21).

In the case where the mask 8′ is formed of chromium oxide or chromium as a main material thereof, the initial holes 81′ can be easily formed by an initial hole formation process (will be described later), and the substrate 7′ can be protected at the etching process more surely. Further, in the case where the mask 8′ is formed of chromium oxide or chromium as a main material thereof, a solution of ammonium hydrogen difluoride (NH₄HF₂), for example, may be used as an etchant at the etching process (will be described later). Since a solution containing ammonium hydrogen difluoride is not poison, it is possible to prevent its influence on human bodies during work and on the environment more surely.

Although the thickness of the mask 8′ also varies depending upon the material constituting the mask 8′, it is preferable that the thickness of the mask 8′ is in the range of 0.01 to 2.0 μm, and more preferably it is in the range of 0.03 to 0.2 μm. If the thickness of the mask 8′ is below the lower limit given above, there is a possibility to deform the shapes of the initial holes 81′ formed at the initial hole formation process (will be described later). In addition, there is a possibility that sufficient protection for the masked portion of the substrate 7′ cannot be obtained during a wet etching process at the etching step (will be described later). On the other hand, if the thickness of the mask 8′ is over the upper limit given above, in addition to the difficulty in formation of the initial holes 81′ that penetrate the mask 8′ at the initial hole formation process (will be described later), there will be a case in which the mask 8′ tends to be easily removed due to internal stress thereof depending upon the constituent material or the like of the mask 8′.

The back surface protective film 89′ is provided for protecting the back surface of the substrate 7′ at the subsequent processes. Erosion, deterioration or the like of the back surface of the substrate 7′ can be suitably prevented by means of the back surface protective film 89′. Since the back surface protective film 89′ is formed using the same material as the mask 8′, it may be provided in a manner similar to the formation of the mask 8′ simultaneously with the formation of the mask 8′.

<B2> Next, as shown in FIG. 7B, the plurality of initial holes 81′ that will be utilized as mask openings at the etching process (will be described later) are formed in the mask 8′ (initial hole formation process). The arrangement of the initial holes 81′ generally depends upon the arrangement of concave portions 91 to be formed, and therefore it is not particularly limited. It is preferable that the initial holes 81′ are arranged so as to become a mirror image relation to the initial holes 81 described above. This makes it possible to suitably manufacture the microlens substrate 1 in which the microlenses 21 and the convex curved portions 22 are arranged to become the positional relation as described above with each other.

The initial holes 81′ may be formed in any method, but it is preferable that the initial holes 81′ are formed by the physical method or the irradiation with laser beams. This makes it possible to manufacture the substrate 9 with concave portions for forming convex curved portions 22 at high productivity. In particular, the concave portions can be easily formed on a relatively large-sized substrate. As for the physical methods of forming the initial holes 81′, for example, etching, pressing, dot printing, blast processing such as shot blast, sand blast or the like, tapping, rubbing, or the like may be mentioned.

Further, in the case where the initial holes 81′ are formed by means of the irradiation with laser beams, the kind of laser beam to be used is not particularly limited, but a ruby laser, a semiconductor laser, a YAG laser, a femtosecond laser, a glass laser, a YVO₄ laser, a Ne—He laser, an Ar laser, a carbon dioxide laser, an excimer laser or the like may be mentioned. Moreover, a waveform of a laser such as SHG (second-harmonic generation), THG (third-harmonic generation), FHG (fourth-harmonic generation) or the like may be utilized. In the case where the initial holes 81′ are formed by means of the irradiation of laser beams, it is possible to easily and precisely control the size of the initial holes 81′, distance between adjacent initial holes 81′, or the like. Furthermore, in the case where the initial holes 81′ are formed by the irradiation with laser beams, by controlling irradiation conditions for the laser beams, it is possible not only to form the initial holes 81′ without forming initial concave portions 71′ (will be described later), but also to form the initial concave portions 71′ having a little variation in shapes, sizes and depths thereof as well as those of initial holes 81′ easily and surely. It is preferable that the initial holes 81′ are formed uniformly on the entire surface of the mask 8′.

More specifically, for example, it is preferable that the shape of each of the formed initial holes 81′ when viewed from above one major surface of the substrate 7′ on which the mask 8′ has been formed is a substantially elliptic shape and each of the initial holes 81′ has the average diameter in the range of 2 to 10 μm. Further, it is preferable that the initial holes 81′ are formed on the mask 8′ at the rate of 1,000 to 1,000,000 holes per square centimeter (cm²), and more preferably they are formed at the rate of 10,000 to 500,000 holes per square centimeter (cm²). In this regard, needless to say, the shape of each of the initial holes 81′ is not limited to the substantially elliptic shape.

When the initial holes 81′ are formed in the mask 8′, as shown in FIG. 7B, the initial concave portions 71′ may also be formed in the substrate 7′ by removing parts of the surface of the substrate 7′ in addition to the initial holes 81′. This makes it possible to increase contact area of the substrate 7′ with the etchant when subjecting the substrate 7′ with the mask 8′ to the etching process (will be described later), whereby erosion can be started suitably. Further, by adjusting the depth of each of the initial concave portions 71′, it is also possible to adjust the depth of the concave portions 91 (that is, the maximum thickness of the lens (convex curved portion 22)). Although the depth of each of the initial concave portions 71′ is not particularly limited, it is preferable that it is 5.0 μm or less, and more preferably it is in the range of about 0.1 to 0.5 μm. In the case where the formation of the initial holes 81′ is carried out by means of the irradiation with laser beams, it is possible to surely reduce variation in the depth of each of the plurality of initial concave portions 71′ formed together with the initial holes 81′. This makes it possible to reduce variation in the depth of each of the concave portions 91 constituting a substrate 9 with concave portions for forming convex curved portions 22, and therefore it is possible to reduce variation in the size and shape of each of the convex curved portions 22 in the microlens substrate 1 obtained finally. As a result, it is possible to reduce variation in the diameter, the radius of curvature or the like of the lens of each of the convex curved portions 22, in particular.

Further, other than by means of the physical method or the irradiation with laser beams, the initial holes 81′ may be formed in the formed mask 8′ by, for example, previously arranging foreign objects on the substrate 7′ with a predetermined pattern when the mask 8′ is formed on the substrate 7′, and then forming the mask 8′ on the substrate 7′ with the foreign objects to form defects in the mask 8′ by design so that the defects are utilized as the initial holes 81′.

In this way, in the invention, by forming the initial holes 81′ in the mask 8′ by means of the physical method or the irradiation with laser beams, it is possible to form openings (initial holes 81′) in the mask 8′ easily and inexpensively compared with the formation of the openings in the mask 8′ by means of a conventional photolithography method. Further, according to the physical method or the irradiation with laser beams, it is possible to deal with a large-sized substrate easily.

<B3> Next, as shown in FIG. 7C, a large number of concave portions 91 are formed in the substrate 7′ by subjecting the substrate 7′ to the etching process using the mask 8′ in which the initial holes 81′ are formed (etching process). The etching method is not particularly limited, and as for the etching method, a wet etching process, a dry etching process and the like may be mentioned, for example. In the following explanation, the case of using the wet etching process will be described as an example.

By subjecting the substrate 7′ covered with the mask 8′ in which the initial holes 81′ are formed to the wet etching process, as shown in FIG. 7C, the substrate 7′ is eroded from the portions where no mask 8′ is present, whereby a large number of concave portions 91 are formed in the substrate 7′. As mentioned above, since the initial holes 81′ formed in the mask 8′ are arranged in a houndstooth check manner, the concave portions 91 to be formed are also arranged on the surface of the substrate 7′ in a houndstooth check manner.

Further, in the present embodiment, the initial concave portions 71′ are formed on the surface of the substrate 7′ when the initial holes 81′ are formed in the mask 8′ at step <B2>. This makes the contact area of the substrate 7′ with the etchant increase during the etching process, whereby erosion can be made to start suitably. Moreover, the concave portions 91 can be formed suitably by employing the wet etching process. In the case where an etchant containing hydrofluoric acid (hydrogen fluoride) (that is, hydrofluoric acid-based etchant) is utilized for an etchant, for example, the substrate 7′ can be eroded more selectively, and this makes it possible to form the concave portions 91 suitably.

In the case where the mask 8′ is mainly constituted from chromium (that is, the mask 8′ is formed of a material containing Cr as a main material thereof), a solution of ammonium hydrogen difluoride is particularly suited as a hydrofluoric acid-based etchant. Since a solution containing ammonium hydrogen difluoride (4% by weight or less aqueous solution thereof) is not poison, it is possible to prevent its influence on human bodies during work and on the environment more surely. Further, in the case where the solution of ammonium hydrogen difluoride is used as an etchant, for example, hydrogen peroxide may be contained in the etchant. This makes it possible to accelerate the etching speed.

Further, the wet etching process can be carried out with simpler equipment than that at the dry etching process, and it allows the processing for a larger number of substrates 7 at a time. This makes it possible to enhance productivity of the substrates 6, and it is possible to provide the substrate 9 with concave portions for forming convex curved portions 22 at a lower cost.

Each of the concave portions (concave portions for forming convex curved portion 22) 91 formed at the present step has a radius of curvature larger than that of each of the concave portions (concave portions for forming microlenses 21) 61 in the substrate 6 with concave portions for forming microlenses 21 described above. Such concave portions 91 can be suitably formed by making an etching time longer than that in forming the concave portions 61 described above, heightening an etching temperature compared with that in forming the concave portions 61, using an etchant having higher concentration than that of the etchant used in forming the concave portions 61, or the like.

<B4> Next, the mask 8′ is removed as shown in FIG. 7D (mask removal process). At this time, the back surface protective film 89′ is also removed along with the mask 8′. In the case where the mask 8′ is constituted from chromium as a main material thereof, the removal of the mask 8′ can be carried out by means of an etching process using a mixture of ceric ammonium nitrate and perchloric acid, for example.

As a result of the processing in the above, as shown in FIGS. 7D and 6, a substrate 9 with concave portions for forming convex curved portions 22 in which a large number of concave portions 91 are formed in the substrate 7′ in a houndstooth check manner is obtained.

The method of forming the plurality of concave portions 91 in the substrate 7′ in a houndstooth check manner is not particularly limited. In the case where the concave portions 91 are formed by means of the method mentioned above, that is, the method of forming the concave portions 91 in the substrate 7′ by forming the initial holes 81′ in the mask 8′ by means of the physical method or the irradiation with laser beams and then subjecting the substrate 7′ to the etching process using the mask 8′, it is possible to obtain the following effects.

Namely, by forming the initial holes 81′ in the mask 8′ by means of the physical method or the irradiation with laser beams, it is possible to form openings (initial holes 81′) in a predetermined pattern in the mask 8′ easily and inexpensively compared with the case of forming the openings in the mask 8′ by means of the conventional photolithography method. This makes it possible to enhance productivity of the substrate 9 with concave portions for forming convex curved portions 22, whereby it is possible to provide the substrate 9 with concave portions for forming convex curved portions 22 at a lower cost.

Further, according to the method as described above, it is possible to carry out the processing for a large-sized substrate easily. Also, according to the method, in the case of manufacturing such a large-sized substrate, there is no need to bond a plurality of substrates as the conventional method, whereby it is possible to eliminate the appearance of seams of bonding. This makes it possible to manufacture a high quality large-sized substrate 9 with concave portions for forming convex curved portions 22 (that is, microlens substrate 1) by means of a simple method at a low cost.

In particular, in the case of forming the initial holes 81′ by means of the irradiation of laser beams, it is possible to control the shape and size of each of the initial holes 81′ to be formed, arrangement thereof, and the like easily and surely.

Further, in the case where the microlenses 21 and the convex curved portions 22 are arranged regularly as shown in FIG. 2 (that is, they are arranged in houndstooth check manner), it is possible to form the initial holes 81 of the mask 8 and the initial holes 81′ of the mask 8′ with the same pattern. This makes it possible to manufacture the substrate 6 with concave portions for forming microlenses 21 and the substrate 9 with concave portions for forming convex curved portions 22 only by changing etching conditions such as an etching time. In other words, since it is possible to manufacture the substrate 6 with concave portions for forming microlenses 21 and the substrate 9 with concave portions for forming convex curved portions 22 using a common material and a common manufacturing method only by changing the etching conditions, it is possible to improve the productivities of the substrate 6 with concave portions for forming microlenses 21, the substrate 9 with concave portions for forming convex curved portions 22, and the microlens substrate 1.

Moreover, after the mask 8′ is removed at step <B4>, a new mask may be formed on the substrate 7′, and then a series of processes including the mask formation process, the initial hole formation process, the wet etching process and the mask removal process may be repeated. This makes it possible to obtain the substrate 9 with concave portions for forming convex curved portions 22 in which the concave portions 91 are formed densely.

Next, the method of manufacturing the microlens substrate 1 using the substrate 6 with concave portions for forming microlenses 21, the substrate 9 with concave portions for forming convex curved portions 22 will now be described.

<C1> As shown in FIG. 8A, a resin 23 having fluidity (for example, a resin 23 at a softened state, a non-polymerized (uncured) resin 23) is supplied to the surface of the substrate 6 with concave portions for forming microlenses 21 on which the concave portions 61 are formed. The resin 23 is pushed by the substrate 9 with concave portions for forming convex curved portions 22 so that the surface of the substrate 6 with concave portions for forming microlenses 21 on which the concave portions 61 are formed faces the surface of the substrate 9 with concave portions for forming convex curved portions 22 on which the concave portions 91 are formed. In particular, in the present embodiment, at this step, the resin 23 is pushed while spacers 20 are provided between the substrate 6 with concave portions for forming microlenses 21 and the substrate 9 with concave portions for forming convex curved portions 22. Thus, it is possible to control the thickness of the formed microlens substrate 1 more surely, and this makes it possible to control the focal points of the respective microlenses 21 in the microlens substrate 1 finally obtained more surely. Therefore, it is possible to prevent disadvantage such as color heterogeneity from being generated efficiently.

Each of the spacers 20 is formed of a material having an index of refraction nearly equal to that of the resin 23 (the resin 23 at a solidified state). By using the spacers 20 formed of such a material, it is possible to prevent the spacers 20 from having a harmful influence on the optical characteristics of the obtained microlens substrate 1 even in the case where the spacers 20 are arranged in portions in each of which any concave portion 61 of the substrate 6 with concave portions for forming microlenses 21 and any concave portion 91 of the substrate 9 with concave portions for forming convex curved portions 22 are formed. This makes it possible to provide a relatively large number of spacers 20 in a wide region of the space between the substrate 6 with concave portions for forming microlenses 21 and the substrate 9 with concave portions for forming convex curved portions 22. As a result, it is possible to get rid of the influence due to flexure of the substrate 6 with concave portions for forming microlenses 21 and/or the substrate 9 with concave portions for forming convex curved portions 22, or the like efficiently, and this makes it possible to control the thickness of the obtained microlens substrate 1 more surely.

Although the spacers 20 are formed of the material having an index of refraction nearly equal to that of the resin 23 (the resin 23 at a solidified state) as described above, more specifically, it is preferable that the absolute value of the difference between the absolute index of refraction of the constituent material of the spacer 20 and the absolute index of refraction of the resin 23 at a solidified state is 0.20 or less, and more preferably it is 0.10 or less. Further more preferably it is 0.20 or less, and most preferably the spacer 20 is formed of the same material as that of the resin 23 at a solidified state.

The shape of each of the spacers 20 is not particularly limited. It is preferable that the shape of the spacer 20 is a substantially spherical shape or a substantially cylindrical shape. In the case where each of the spacers 20 has such a shape, it is preferable that the diameter of the spacer 20 is in the range of 10 to 300 μm, and more preferably it is in the range of 30 to 200 μm. Further more preferably, it is in the range of 30 to 170 μm.

In this regard, in the case of using the spacers 20 as described above, the spacers 20 may be provided between the substrate 6 with concave portions for forming microlenses 21 and the substrate 9 with concave portions for forming convex curved portions 22 when solidifying the resin 23. Thus, the timing to supply the spacers 20 is not particularly limited. Further, for example, a resin 23 in which the spacers 20 are dispersed in advance may be utilized as a resin to be supplied onto the surface of the substrate 6 with concave portions for forming microlenses 21 on which the concave portions 61 are formed, or the resin 23 may be supplied thereon while the spacers 20 are provided on the surface of the substrate 6 with concave portions for forming microlenses 21. Alternatively, the spacers 20 may be supplied onto the surface of the substrate 6 with concave portions for forming microlenses 21 after supplying the resin 23 thereto.

Further, prior to the supply of the resin 23 and the pressing process by means of the substrate 9 with concave portions for forming convex curved portions 22, a mold release agent or the like may be applied to the surface of the substrate 6 with concave portions for forming microlenses 21 on which the concave portions 61 are formed and/or the surface of the substrate 9 with concave portions for forming convex curved portions 22 on which the concave portions 91 are formed. This makes it possible to separate the microlens substrate 1 from the substrate 6 with concave portions for forming microlenses 21 and the substrate 9 with concave portions for forming convex curved portions 22 easily and surely at the following steps.

<C2> Next, the resin 23 is solidified (including “hardened (polymerized)”), and then the substrate 9 with concave portions for forming convex curved portions 22 is removed (see FIG. 8B), and further the substrate 6 with concave portions for forming microlenses 21 is removed (see FIG. 8C). In this way, the microlens substrate 1 (main substrate 2) provided with the plurality of microlenses 21 constituted from the resin filled in the plurality of concave portions 61 each of which serves as a convex lens and the plurality of convex curved portions 22 constituted from the resin filled in the plurality of concave portions 91 each of which serves as a convex lens is obtained.

In the case where solidification of the resin 23 is carried out in a hardened (polymerized) manner, as for the method of hardening the resin 23, for example, irradiation of light such as ultraviolet rays, heating, electron beam irradiation, or the like may be mentioned.

Further, in the case where the microlens substrate 1 is provided with a light shielding portion such as a black matrix (not shown in the drawings), it is possible to form the light shielding portion as follows.

First, as shown in FIG. 8B, by removing the substrate 9 with concave portions for forming convex curved portions 22 from the resin 23, the surface of the resin 23 on which the plurality of convex curved portions 22 of the main substrate 2 is exposed.

Next, a liquid for forming light shielding portion that contains a coloring agent (light shielding agent) having fluidity is supplied onto the exposed surface of the main substrate 2.

The main substrate 2 is left at a state in which the surface of the main substrate 2 on which the convex curved portions 22 are formed faces upward (in this case, the main substrate 2 is left after eliminating excess coloring agent left on the main substrate 2 by wiping it out if needed), or the main substrate 2 is heated, whereby the liquid for forming light shielding portion is hardened. As a result, the light shielding portion is formed in a plurality of troughs formed between adjacent convex curved portions 22.

In this way, in the case where the microlens substrate 1 is provided with the plurality of convex curved portions 22, it is possible to form the light shielding portion easily and surely.

Hereinafter, a description will be given for a rear projection using the transmission screen described above.

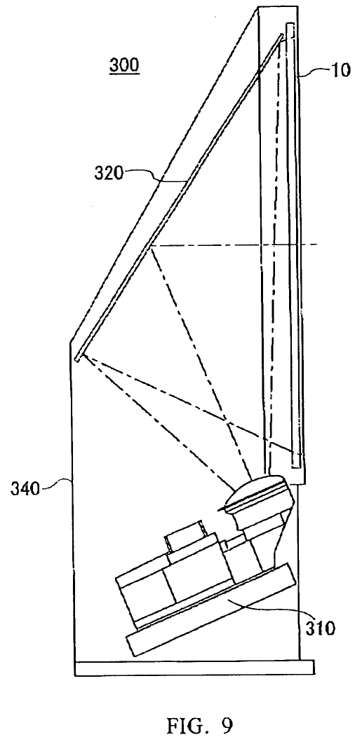

FIG. 9 is a cross-sectional view which schematically shows a rear projection 300 to which the transmission screen 10 of the invention is applied. As shown in FIG. 9, the rear projection 300 has a structure in which a projection optical unit 310, a light guiding mirror 320 and a transmission screen 10 are arranged in a casing 340.

Since the rear projection 300 uses the transmission screen 10 that has excellent angle of view characteristics and light use efficiency as described above, it is possible to obtain image having excellent contrast. In addition, since the rear projection 300 has the structure as described above in the present embodiment, it is possible to obtain excellent angle of view characteristics and light use efficiency, in particular.

Further, since the microlenses 21 each having a substantially ellipse shape are arranged in a houndstooth check manner on the microlens substrate 1 described above, the rear projection 300 hardly generates problems such as moire.

As described above, it should be noted that, even though the lens substrate (microlens substrate 1), the method of manufacturing a lens substrate, the transmission screen 10 and the rear projection 300 according to the invention have been described with reference to the preferred embodiments shown in the accompanying drawings, the invention is not limited to these embodiments. For example, each element (component) constituting the lens substrate (microlens substrate 1), the transmission screen 10 and the rear projection 300 may be replaced with one capable of performing the same or a similar function.

Further, in the embodiment described above, even though it has been described that the spacers 20 each having an index of refraction nearly equal to that of the resin 23 (that is, the resin 23 after solidification) are used as spacers, each of the spacers 20 having an index of refraction nearly equal to that of the resin 23 (that is, the resin 23 after solidification) is not required in the case where the spacers 20 are arranged only in the region where neither the concave portions 61 of the substrate 6 with concave portions for forming microlenses 21 or the concave portions 91 of the substrate 9 with concave portions for forming convex curved portions 22 are formed (unusable lens area). Moreover, the spacers 20 as described above do not always have to be utilized in manufacturing the lens substrate (microlens substrate 1).

Moreover, in the embodiment described above, even though it has been described that the resin 23 is supplied onto the surface of the substrate 6 with concave portions for forming microlenses 21, the microlens substrate 1 may be manufactured so that, for example, the resin 23 is supplied onto the surface of the substrate 9 with concave portions for forming convex curved portions 22 and the resin 23 is then pressed by the substrate 6 with concave portions for forming microlenses 21.

Furthermore, in the embodiment described above, even though it has been described that at the initial hole formation step in the method of manufacturing the substrate 6 with concave portions for forming microlenses 21 the initial concave portions 71 was formed in the substrate 7 in addition to the initial holes 81, there is no need to form such initial concave portions 71. By appropriately adjusting the formation conditions for the initial holes 81 (for example, energy intensity of a laser, the beam diameter of the laser, irradiation time or the like), it is possible to form the initial concave portions 71 each having a predetermined shape, or it is possible to selectively form only the initial holes 81 so that the initial concave portions 71 are not formed. Further, the same applies to the initial holes 81′ of the substrate 9 with concave portions for forming convex curved portions 22.

Further, in the embodiment described above, even though it has been described that the lens substrate (microlens substrate 1) is provided with the convex curved portions 22 as the total reflection preventing means, the total reflection preventing means even can prevent the light entering the lens substrate from being totally reflected in the vicinity of the light emission surface thereof, and it is not limited to the convex curved portions 22.

Moreover, in the embodiment described above, even though it has been described that the microlenses 21 each having a substantially elliptic shape when viewed from above the light incident surface or the light emission surface of the lens substrate (microlens substrate 1) are arranged in a houndstooth check manner, the shape and arrangement of the microlenses 21 are not limited to the above. For example, the microlenses 21 may be arranged in a lattice-like pattern, or may be formed in a honeycombed pattern. Alternatively, the microlenses 21 may be arranged in a random manner.

Furthermore, in the embodiment described above, even though it has been described that the transmission screen 10 is provided with the microlens substrate (lens substrate) 1 and the Fresnel lens 5, the transmission screen 10 of the invention need not be provided with the Fresnel lens 5 necessarily. For example, the transmission screen 10 may be constructed from only the microlens substrate (lens substrate) 1 of the invention practically.

Further, in the embodiment described above, even though it has been described that the total reflection preventing means is arranged over the light incident surface of the lens substrate (microlens substrate 1), the total reflection preventing means may be provided only at a part of the light emission surface of the lens substrate (microlens substrate 1).

Moreover, in the embodiment described above, even though the structure where the microlens substrate 1 (lens substrate) is provided with the microlenses 21 as lens portions has been described, the lens portions constituting the lens substrate is not limited to the microlenses 21. For example, the lens portions may be lenticular lenses. By using the lenticular lenses, it is possible to simplify the manufacturing step for the lens portions, and therefore, it is possible to improve the productivity of the transmission screen 10.

Furthermore, in the embodiments described above, even though it has been described that the lens substrate (microlens substrate 1) is a member constituting the transmission screen 10 or the rear projection 300, the lens substrate (microlens substrate 1) is not limited to one to be applied to a transmission screen 10 or rear projection 300, and it may be applied to one for any use. For example, the lens substrate (microlens substrate 1) may be applied to a constituent member of a liquid crystal light valve in a projection display (front projection).

### EXAMPLE

<Manufacture of Lens Substrate and Transmission Screen>

### Example 1

A substrate with concave portions for forming microlenses equipped with concave portions for forming microlenses was manufactured in the following manner.

First, a soda-lime glass substrate having a rectangle shape of 1.2 m×0.7 m and a thickness of 4.8 mm was prepared.

The substrate of soda-lime glass was soaked in cleaning liquid containing 4% by weight ammonium hydrogen difluoride and 8% by weight hydrogen peroxide to carry out a 6 μm etching process, thereby cleaning its surface. Then, cleaning with pure water and drying with nitrogen (N₂) gas (for removal of pure water) were carried out.

Next, a laminated structure constructed from a layer formed of chromium and a layer formed of chromium oxide (that is, the laminated structure in which the chromium layer was laminated on the outer surface of the chromium oxide layer) was formed on the soda-lime glass substrate by means of a sputtering method. Namely, a mask and a back surface protective film each made of the laminated structure constructed from the layer formed of chromium and the layer formed of chromium oxide were formed on both surfaces of the substrate of soda-lime glass. In this regard, the thickness of the chromium layer is 0.02 μm, while the thickness of the chromium oxide layer is 0.02 μm.

Next, laser machining was carried out to the mask to form a large number of initial holes within a region of 113 cm×65 cm at the central part of the mask. In this regard, the laser machining was carried out using a YAG laser under the conditions of energy intensity of 1 mW, a beam diameter of 3 μm, and an irradiation time of 60×10⁻⁹ seconds. In this way, the initial holes each having a predetermined length were formed in a houndstooth check pattern over the entire region of the mask mentioned above. The average width and the average length of the initial holes were 2 μm and 5 μm, respectively. Further, the formation density of the initial holes was 40,000 holes/cm².

In addition, at this time, concave portions each having a depth of about 0.1 μm and a damaged layer (or affected layer) were formed on the surface of the soda-lime glass substrate.

Next, the soda-lime glass substrate was subjected to a wet etching process, thereby forming a large number of concave portions each having a substantially elliptic shape (concave portions for forming microlenses) on the soda-lime glass substrate. The large number of concave portions thus formed had substantially the same shape as each other. The length of each of the formed concave portions in the minor axis direction was 50 μm, and the length of each of the formed concave portions in the major axis direction was 70 μm. Further, the radius of curvature thereof was 38 μm.

In this regard, an aqueous solution containing 4% by weight ammonium hydrogen difluoride and 8% by weight hydrogen peroxide was used for the wet etching process as an etchant, and the soak time of the substrate was 1.5 hours.

Next, the laminated structures of chromium/chromium oxide (the mask and back surface protective film) were removed by carrying out an etching process using a mixture of ceric ammonium nitrate and perchloric acid. Then, cleaning with pure water and drying with N₂ gas (removal of pure water) were carried out.

As a result, a wafer-like substrate with concave portions for forming microlenses in which a large number of concave portions for forming microlenses were arranged in a houndstooth check manner on the soda-lime glass substrate was obtained. A ratio of an area occupied by all the concave portions in a usable area where the concave portions were formed with respect to the entire usable area was 97% when viewed from above any one of the light incident surface and the light emission surface of the obtained substrate with concave portions. A large number of distances between arbitrarily adjacent two points in the substrate with concave portions for forming microlenses (that is, the distance between the center of a concave portion and the center of an adjacent concave portion) were measured, and a standard deviation of these distances was then calculated. The standard deviation obtained by such a calculation was 32% of the average value of the large number of distances.

Next, a substrate with concave portions for forming convex curved portions equipped with concave portions for forming convex curved portions was manufactured in the following manner.

First, a soda-lime glass substrate having a rectangle shape of 1.2 m×0.7 m and a thickness of 4.8 mm was prepared.

The substrate of soda-lime glass was subjected to soaking in cleaning liquid, cleaning with pure water and drying with nitrogen (N₂) gas, formation of mask and back surface protective film, and formation of initial holes by means of laser machining as well as the manufacture of the substrate with concave portions for forming microlenses as described above.

Next, the soda-lime glass substrate was subjected to a wet etching process, thereby forming a large number of concave portions each having a substantially elliptic shape (concave portions for forming convex curved portions) on the soda-lime glass substrate. The large number of concave portions thus formed had substantially the same shape as each other. The length of each of the formed concave portions in the minor axis direction is 30 μm, and the length of each of the formed concave portions in the major axis direction is 45 μm. Further, the radius of curvature thereof is 500 μm.

In this regard, an aqueous solution containing 4% by weight ammonium hydrogen difluoride and 8% by weight hydrogen peroxide was used for the wet etching process as an etchant, and the soak time of the substrate was 1.5 hours.

Next, the laminated structures of the chromium/chromium oxide (the mask and back surface protective film) were removed by carrying out an etching process using a mixture of ceric ammonium nitrate and perchloric acid. Then, cleaning with pure water and drying with N₂ gas (removal of pure water) were carried out.

As a result, a wafer-like substrate with concave portions for forming convex curved portions in which a large number of concave portions for forming convex curved portions were arranged in a houndstooth check manner on the soda-lime glass substrate was obtained. A ratio of an area occupied by all the concave portions in a usable area where the concave portions were formed with respect to the entire usable area was 100% when viewed from above any one of the light incident surface and the light emission surface of the obtained substrate with concave portions. A large number of distances between arbitrarily adjacent two points in the substrate with concave portions for forming microlenses (that is, the distance between the center of a concave portion and the center of an adjacent concave portion) were measured, and a standard deviation of these distances was then calculated. The standard deviation obtained by such a calculation was 5% of the average value of the large number of distances.

Next, a microlens substrate was manufactured in the following manner using the substrate with concave portions for forming microlenses and the substrate with concave portions for forming convex curved portions obtained as described above.

First, a mold release agent (GF-6110) was applied to the surface of the substrate with concave portions for forming microlenses obtained as described above on which the concave portions were formed, and a non-polymerized (uncured) ultraviolet-ray (UV) curing resin (UV-cure resin) (V-2403 (made by Nippon Steel Chemical Co., Ltd.)) was applied to the same surface side. At this time, substantially spherical-shaped spacers (each having a diameter of 2 μm) formed of hardened material of the ultraviolet-ray (UV) curing resin (UV-cure resin) (V-2403 (made by Nippon Steel Chemical Co., Ltd.)) were arranged over the substantially entire surface of the substrate with concave portions for forming microlenses. Further, the spacers are arranged at the rate of about 3 pieces/cm².

Next, the UV-cure resin was pressed (pushed) with the surface side of the substrate with concave portions for forming convex curved portions obtained as described above on which the concave portions were formed. At this time, this process was carried out so that air was not intruded between the substrate with concave portions for forming convex curved portions and the UV-cure resin. Further, a mold release agent (GF-6110) was applied to the surface of the substrate with concave portions for forming convex curved portions obtained as described above on which the concave portions were formed prior to the step of pushing the UV-cure resin.

Next, by irradiating ultraviolet rays of 10,000 mJ/cm² through the substrate with concave portions for forming convex curved portions, the UV-cure resin was cured.

The substrate with concave portions for forming convex curved portions and the substrate with concave portions for forming microlenses were then released in this order to obtain a microlens substrate (main substrate) on the major surfaces of which a large number of microlenses each having a substantially elliptic shape and a large number of convex curved portions each having a substantially elliptic shape were respectively formed. The index of refraction of the obtained microlens substrate (the resin after solidification) was 1.52. Further, the thickness of the resin layer in the obtained microlens substrate (portion except for the convex portions of the microlenses and the convex curved portions) was 2 μm, and the radius of curvature of each of the plurality of microlenses were respectively 38 μm. The length of each of the formed microlenses in the minor axis direction was 50 μm, and the length of each of the formed convex curved portions in the major axis direction was 38 μm. Further, the radius of curvature each of the formed convex curved portions in the major axis direction was 30 μm. Moreover, a ratio of an area (projected area) occupied by all the microlenses in a usable area where the microlenses were formed with respect to the entire usable area was 97% when viewed from above any one of the light incident surface and the light emission surface of the obtained microlens substrate.

By assembling the microlens substrate manufactured as described above and a Fresnel lens manufactured by extrusion molding, the transmission screen as shown in FIG. 3 was obtained.

### Example 2

A microlens substrate and a transmission screen were manufactured in the manner similar to those in Example 1 except that a light shielding portion (black matrix) was formed at the surface side thereof on which the convex curved portions were formed. The formation of the light shielding portion was carried out in the following manner.

A substrate with concave portions for forming convex curved portions was released from the obtained main substrate after curing the UV-cure resin as well as Example 1 described above.

Then, a liquid for forming a light shielding portion (that is, dispersion liquid) fabricated by diluting black paint (TAMIYA color XF1 made by TAMIYA, in this example) with equal amount of water was supplied onto the exposed surface side of the main substrate. The supply of the liquid for forming a light shielding portion was carried out by means of a spray method. In this case, the black paint was an acrylic based paint. Further, the coefficient of viscosity of the liquid for forming a light shielding portion was 5 cP at the room temperature of 25° C.

Next, the liquid for forming a light shielding portion that adhered to the troughs provided between adjacent convex curved portions was eliminated by spraying compressed air to the surface of the main substrate onto which the liquid for forming a light shielding portion had been supplied.

Next, the microlens substrate was desiccated by leaving it at room temperature for a day in the state where the major surface of the microlens substrate on which the convex curved portions were provided faced upward. Thus, a solvent or a dispersion medium in the liquid for forming a light shielding portion was removed therefrom, whereby the light shielding portion was formed on the troughs between adjacent convex curved portions.

A microlens substrate was then obtained by eliminating the substrate with concave portions for forming microlenses.

### Examples 3 to 5

The shape and/or arrangement pattern of each of the concave portions in the substrate with concave portions for forming convex curved portions were changed by appropriately changing irradiation conditions for the laser beams, and/or a soak time into an etchant. In this way, microlens substrates and transmission screens in respective Examples 3 to 5 were manufactured in the manner similar to that in Example 1 except that the shape and/or arrangement pattern of the convex curved portions to be formed in the microlens substrate were changed as shown in TABLE 1.

### Examples 6 to 8

The shape and/or arrangement pattern of each of the concave portions in the substrate with concave portions for forming microlenses were changed by appropriately changing irradiation conditions for the laser beams, and/or a soak time into an etchant. In this way, microlens substrates and transmission screens were manufactured in the manner similar to that in Example 1 except that the shape and/or arrangement pattern of the microlenses formed in the microlens substrate were changed as shown in TABLE 1.

### Comparative Example 1

A microlens substrate and a transmission screen were manufactured in the manner similar to that in Example 1 except that a flat plate formed of a soda-lime glass (in this case, the surface roughness Ra thereof is 0.002 μm or less) was used in place of the substrate with concave portions for forming convex curved portions.

### Comparative Example 2

A microlens substrate was manufactured in the manner similar to that in Example 1 except that a flat plate formed of a soda-lime glass that had been subjected to hairline processing was used in place of the substrate with concave portions for forming convex curved portions. In this regard, the hairline processing to the flat plate formed of soda-lime glass was carried out by minutely scratching with the use of a 1,000 grid sand paper formed of aluminum oxide. In the obtained microlens substrate, the scratches by the hairline processing were provided at the surface opposite to the surface on which microlenses were formed.

Further, a transmission screen was manufactured in the manner similar to that in Example 1 using the microlens substrate obtained as described above.

### Comparative Example 3

A main substrate was manufactured in the manner similar to that in Example 1 except that a flat plate formed of a soda-lime glass (in this case, the surface roughness Ra thereof is 0.003 μm or less) was used in place of the substrate with concave portions for forming convex curved portions.

A non-reflecting coat layer was formed at the surface opposite to the surface on which the microlenses were formed in the main substrate manufactured as described above, whereby a microlens substrate was obtained. The non-reflecting coat layer was formed by laminating a plurality of thin membranes each having a different index of refraction by means of a dipping method.

Further, a transmission screen was manufactured in the manner similar to that in Example 1 using the microlens substrate obtained as described above.

The shape of each of the convex curved portions, the arrangement pattern thereof, the shape of each of the microlenses, the arrangement pattern thereof and the like in each of Examples 1 to 8 and Comparative Examples 1 to 3 were shown in TABLE 1 as a whole.

TABLE 1

| | Microlens | | | | | |
|---|---|---|---|---|---|---|
| | | | Short Axis | | | |
| | | | Length | Long Axis | Radium of | |
| | | | (Diameter) | Length | Curvature | Convex portion |
| | Arrangement | Shape | L₁ (μm) | L₂ (μm) | R₁ (μm) | Arrangement |
| EX. 1 | Houndstooth | Substantially | 50 | 70 | 38 | Houndstooth |
| | | Elliptic | | | | |
| EX. 2 | Houndstooth | Substantially | 50 | 70 | 38 | Houndstooth |
| | | Elliptic | | | | |
| EX. 3 | Houndstooth | Substantially | 50 | 70 | 38 | Houndstooth |
| | | Elliptic | | | | |
| EX. 4 | Lattice | Substantially | 50 | 50 | 38 | Houndstooth |
| | | Elliptic | | | | |
| EX. 5 | Random | — | 50 | 70 | 38 | Houndstooth |
| EX. 6 | Houndstooth | Substantially | 40 | 65 | 35 | Houndstooth |
| | | Elliptic | | | | |
| EX. 7 | Lattice | — | 30 | 40 | 23 | Lattice |
| EX. 8 | Random | — | 60 | 90 | 49 | Random |
| Co-EX. 1 | Houndstooth | Substantially | 50 | 70 | 38 | — |
| | | Elliptic | | | | |
| Co-EX. 2 | Houndstooth | Substantially | 50 | 70 | 38 | — |
| | | Elliptic | | | | |
| Co-EX. 3 | Houndstooth | Substantially | 50 | 70 | 38 | — |
| | | Elliptic | | | | |

| | Convex portion | | | | Presence or | | |
|---|---|---|---|---|---|---|---|
| | | Short Axis | | | Absence of | | |
| | | Length | Long Axis | Radium of | Light | | |
| | | (Diameter) | Length | Curvature | Shielding | | |
| | Shape | (μm) | (μm) | R₂ (μm) | portion | L₁/L₂ | R₂/R₁ |
| EX. 1 | Substantially | 30 | 45 | 500 | Absence | 0.71 | 13.2 |
| | Elliptic | | | | | | |
| EX. 2 | Substantially | 40 | 50 | 800 | Presence | 0.71 | 21.1 |
| | Elliptic | | | | | | |
| EX. 3 | Lattice | 70 | 70 | 600 | Presence | 0.71 | 15.8 |
| EX. 4 | Substantially | 60 | 80 | 700 | Presence | 0.71 | 18.4 |
| | Elliptic | | | | | | |
| EX. 5 | Substantially | 30 | 45 | 600 | Presence | 0.71 | 15.8 |
| | Elliptic | | | | | | |
| EX. 6 | Substantially | 30 | 45 | 500 | Presence | 0.62 | 14.3 |
| | Elliptic | | | | | | |
| EX. 7 | Substantially | 30 | 45 | 500 | Presence | 0.75 | 21.7 |
| | Elliptic | | | | | | |
| EX. 8 | Substantially | 30 | 45 | 500 | Presence | 0.67 | 10.2 |
| | Elliptic | | | | | | |
| Co-EX. 1 | — | — | — | — | Absence | 0.71 | — |
| Co-EX. 2 | — | — | — | — | Absence | 0.71 | — |
| Co-EX. 3 | — | — | — | — | Absence | 0.71 | — |

<Manufacture of Rear Projection>

A rear projection as shown in FIG. 9 was manufactured (assembled) using the transmission screen manufactured in each of Examples 1 to 8 and Comparative Examples 1 to 3.

<Evaluation for Contrast>

The evaluation for contrast was carried out with respect to the rear projection of each of Examples 1 to 8 and Comparative Examples 1 to 3 described above.

A ratio LW/LB of front side luminance (white luminance) LW (cd/m²) of white indication when total white light having illuminance of 413 luces entered the transmission screen in the rear projection at a dark room to the increasing amount of front side luminance (black luminance increasing amount) LB (cd/m²) of black indication when a light source was fully turned off at a bright room was calculated as contrast (CNT). In this regard, the black luminance increasing amount is referred to as the increasing amount with respect to luminance of black indication at a dark room. Further, the measurement at the bright room was carried out under the conditions in which the illuminance of outside light was about 185 luces, while the measurement at the dark room was carried out under the conditions in which the illuminance of outside light was about 0.1 luces.

<Evaluation of Color Heterogeneity>

A sample image was displayed on the transmission screen in the rear projection of each of Examples 1 to 8 and Comparative Examples 1 to 3 described above. The generation status of color heterogeneity with respect to the displayed image on the rear projection of each of Examples 1 to 8 and Comparative Examples 1 to 3 was evaluated.

<Measurement of Angle of View>

The measurement of angles of view in both horizontal and vertical directions was carried out while a sample image was displayed on the transmission screen in the rear projection of each of Examples 1 to 8 and Comparative Examples 1 to 3. The measurement of the angles of view was carried out under the conditions in which the measurement was carried out at intervals of one degree with a gonio photometer. These results of the measurement of angles of view were shown in TABLE 2 as a whole.

TABLE 2

| | | | Angle of View (°) | |
|---|---|---|---|---|
| | | | Half Value | |
| | | | Vertical | Horizontal |
| | Contrast | Color Heterogeneity | Direction | Direction |
| EX. 1 | 650 | Not Occur | 22 | 21 |
| EX. 2 | 550 | Not Occur | 21 | 19 |
| EX. 3 | 600 | Not Occur | 22 | 18 |
| EX. 4 | 620 | Not Occur | 22 | 19 |
| EX. 5 | 630 | Not Occur | 20 | 20 |
| EX. 6 | 580 | Not Occur | 22 | 19 |
| EX. 7 | 570 | Not Occur | 22 | 19 |
| EX. 8 | 562 | Not Occur | 20 | 18 |
| Co-EX. 1 | 500 | Occur | 22 | 19 |
| Co-EX. 2 | 450 | Occur | 21 | 20 |
| Co-EX. 3 | 480 | Occur | 22 | 19 |

As seen clearly from TABLE 2, the rear projection in each of Examples 1 to 8 according to the invention had excellent contrast and excellent angle of view characteristics. Further, an excellent image having no color heterogeneity could be displayed on each of the rear projections of the invention. In other words, an excellent image could be displayed on each of the rear projections of the invention stably.

On the other hand, sufficient results could not be obtained from the rear projection in each of Comparative Examples 1 to 3 described above. In particular, in the rear projection in Comparative Example 1, the reflection of outside light appeared markedly, and the contrast of the projected image became significantly low. Further, in the rear projection in each of Comparative Examples 2 and 3, although the reflection of outside light became somewhat better than that of Comparative Example 1, the obtained image became totally dark, and as a result, the contrast thereof was inferior to that of each of Examples 1 to 8, that is, the contrast of the rear projection of the invention. It was thought that this was because the hairline processing and/or non-reflecting coat layer prevent the incident light into the microlens substrate from permeating to the side of a viewer thereof.

What is claimed is:

1. A lens substrate having a first surface and a second surface opposite to the first surface, light being allowed to enter the lens substrate from the first surface thereof and then exit from the second surface thereof, the lens substrate comprising:
a plurality of convex lenses formed on the first surface of the lens substrate from which the light is allowed to enter the lens substrate; and
a total reflection preventing means provided on the second surface of the lens substrate for preventing the light entering the lens substrate from being totally reflected in the vicinity of the second surface thereof.

2. The lens substrate as claimed in claim 1, wherein the total reflection preventing means is constituted from a plurality of convex curved portions.

3. The lens substrate as claimed in claim 2, wherein the radius of curvature of each of the plurality of convex curved portions is in the range of 1.6 to 12,500 μm.

4. The lens substrate as claimed in claim 2, wherein, in the case where the radium of curvature of each of the plurality of convex lenses is defined as R₁ (μm) and the radium of curvature of each of the plurality of convex curved portions is defined as R₂ (μm), then R₁ and R₂ satisfy the relation: 3≦R₂/R₁≦10.

5. The lens substrate as claimed in claim 2, wherein a ratio of an area where the convex curved portions are formed inside a usable area in which the plurality of convex lenses are formed with respect to the usable area when viewed from above any one of the first and second surfaces of the lens substrate is 50% or more.

6. The lens substrate as claimed in claim 2, wherein the apex of each of the convex curved portions and the apex of the corresponding convex lens overlap each other when viewed from above any one of the first and second surfaces of the lens substrate.

7. The lens substrate as claimed in claim 1, wherein the radius of curvature of each of the convex lenses is in the range of 5 to 250 μm.

8. The lens substrate as claimed in claim 1, wherein the lens substrate is constituted from a resin material having an absolute index of refraction in the range of 1.2 to 1.9 as a main material.

9. The lens substrate as claimed in claim 1, wherein each of the convex lenses is a microlens having a substantially circular or elliptic shape when viewed from above any one of the first and second surfaces of the lens substrate.

10. A method of manufacturing a lens substrate having a first surface and a second surface opposite to the first surface, the lens substrate being formed with a plurality of convex lenses on the first surface thereof, light being allowed to enter the lens substrate from the first surface thereof and then exit from the second surface thereof, the method comprising the steps of:
preparing a first substrate formed with a plurality of concave portions on one major surface thereof, each of the plurality of concave portions having a predetermined radius of curvature;
preparing a second substrate formed with a plurality of concave portions on one major surface thereof, each of the plurality of concave portions having a predetermined radius of curvature larger than the radium of curvature of each of the concave portions in the first substrate;
arranging the first and second substrates so that both the one major surfaces thereof on which the plurality of concave portions are respectively formed face with each other to form a space therebetween;
filling the space between the first and second substrates with a resin material having fluidity; and
hardening the filled resin material.

11. The method as claimed in claim 10, wherein in the first and second substrates arranging step spacers each having an index of refraction nearly equal to that of the resin material are provided between the first and second substrates, and in the resin material hardening step the resin material is hardened while the spacers are left as they are.

12. A lens substrate manufactured using the method defined by claim 10.

13. A transmission screen comprising:
a Fresnel lens formed with a plurality of lenses on one major surface thereof, the one major surface of the Fresnel lens constituting an emission surface thereof; and
the lens substrate defined by claim 1, the lens substrate being arranged on the side of the emission surface of the Fresnel lens so that the first surface thereof faces the Fresnel lens.

14. A rear projection comprising the transmission screen defined by claim 13.
